(19) United States
(12) Patent Application Publication
(10) Pub. No.: US 2006/0231225 A1
(43) Pub. Date: Oct. 19, 2006

(54) Foil with iridescent appearance and method for the production thereof

(75) Inventor: Valerie Lejeune, Grenoble (FR)

Correspondence Address: BIRCH STEWART KOLASCH & BIRCH, PO BOX 747, FALLS CHURCH, VA, 22040-0747, US

(73) Assignee: Arjo Wiggins, Issy Les Moulineaux (FR)

(21) Appl. No.: 10/541,072

(22) PCT Filed: Dec. 30, 2003
(86) PCT No.: PCT/FR03/03940

§ 371 Date: May 15, 2006

(30) Foreign Application Priority Data
Jan. 3, 2003 (FR) 03/00030

(51) Int. Cl. D21H 19/66; D21H 25/00; C09D 5/00; B44F 1/14

(52) U.S. Cl. 162/135; 162/205; 427/361; 427/420; 162/181.6

(57) ABSTRACT

The invention relates to a foil with iridescent appearance comprising a layer formed by iridescent pigments mixed with hollow plastic microspheres arranged on the surface of said foil. Said invention also relates to a method for producing a foil with iridescent appearance consisting in coating a substrate with a layer which consists of a mixture of iridescent pigments and an aqueous dispersion of plastic hollow microspheres with the aid of a coating device, in drying said coating and in calendering the thus obtained layer.

The present invention relates to a sheet having an iridescent appearance obtained by coating iridescent pigments onto a substrate and to its process of manufacture.

Papers having an iridescent appearance are already known.

The latter exhibit changing colors or glints according to the angle of inclination of the sheet with respect to the observer, in particular a pearlescent effect.

These optical effects are obtained by the incorporation in the paper of iridescent pigments, the type and the amount of pigments used being chosen according to the effect desired.

These iridescent pigments are used either for the purpose of authentication, for example for a security paper, or for a decorative purpose, for example for a printing-writing paper.

They can be introduced in bulk, by mixing with the paper pulp before the formation of the sheet, or by deposition at the surface, mixed with a coating deposited on the surface of the paper.

The Applicant has taken an interest more particularly in this final method of application.

There are currently various problems posed by the surface application of iridescent pigments.

First, the surface application of iridescent substances can result in excess thicknesses or unevennesses in the surface which are undesirable due to their size.

The paper coated with this iridescent layer no longer exhibits the same surface smoothness or the same printability as the base substrate.

This phenomenon can prove to be incompatible with the fundamental requirements of the product, in particular in applications where the surface layers play a not insignificant role.

Secondly, the application of an iridescent layer can modify the transparency of this substrate, in particular in the regions with a high concentration of substances.

This can prove to be particularly harmful for a tracing paper, for which it is desired to retain the characteristics of transparency.

Another disadvantage of the current production methods is the cost of the pigments used.

The iridescent pigments frequently used include in particular mother-of-pearl extracts, lead salts and titanium oxide-coated mica pigments.

The pigments recognized for their greater iridescent power, such as titanium oxide-coated mica pigments, are also among the most expensive.

Furthermore, the methods of incorporation of the iridescent pigments into the paper do not promote a moderate and reasonable use of the latter.

This is because, mixed with the binder of the coating, the pigments can be partially or completely covered with a nontransparent coating layer which has the effect of eclipsing the optical effect of said pigments.

Consequently, it is mainly the pigments present to the greatest extent at the surface which modify the optical effect of the paper in the end.

Only an excess consumption of pigments thus makes it possible to guarantee a sufficiently intense iridescent effect necessary for easy and rapid recognition of the substrate thus coated.

Another disadvantage of the current iridescent coating layer formulations is the loss, sometimes significant, in gloss of the substrate thus coated.

The choice of the binder is particularly important in this case if a paper having an increased gloss is desired.

This is because the binder can, according to the circumstances, increase the gloss of a matt base substrate or result in a significant loss in gloss for the paper in the end.

In point of fact, in the fields of activity targeted by the Applicant, in particular that of printing-writing papers and luxury papers, a better paper gloss is often valued.

In the same way, a better ink gloss after the printing of the coated substrate is also desirable.

In order to overcome the drawbacks described above, an aim of the present invention is to provide a novel process for manufacturing a sheet having an iridescent appearance, in which the other characteristics of the base substrate, such as the transparency, the printability or the gloss, remain unchanged with the layer, indeed even may be improved.

Another aim of the invention is to provide a novel process for the manufacture of a sheet having a sufficiently pronounced iridescent appearance and which does not require an excessively large minimum amount of iridescent pigments.

The present invention thus consists of a sheet having an iridescent appearance, characterized in that it comprises, at the surface, a layer formed from iridescent pigments as a mixture with hollow plastic microspheres.

According to a preferred form of the invention, the iridescent pigments are of the titanium oxide-coated mica type.

According to another preferred form of the invention, the hollow plastic microspheres are based on styrene-acrylic polymer.

According to a specific form of the invention, the mean diameter of the microspheres is between 0.5 μm and 1.0 μm and is preferably equal to 0.6 μm.

According to a preferred form of the invention, the sheet is calendered and its gloss is greater than or equal to 65, as measured with a BYK-Gardner glossmeter oriented at 75° with respect to the normal.

According to a specific form of the invention, the sheet is transparent or translucent and defines in particular a natural tracing paper.

The invention also comprises a process for manufacturing a sheet having an iridescent appearance, characterized in that:

a substrate is coated, using a coating device, with a layer composed of a mixture of iridescent pigments and of an aqueous dispersion of hollow plastic microspheres,

the coating is dried,

the sheet thus obtained is calendered.

According to a preferred form of the invention, the substrate is a material based on cellulose fibers.

According to a specific form of the invention, the substrate is a plastic material.

According to one embodiment of the invention, the coating device is a metal blade coater.

According to another embodiment of the invention, the coating device is a curtain coater.

According to one embodiment, a steel calender is used, the sheet being calendered several times, in particular between 3 and 5 times, under a pressure of 80 N/m².

According to another embodiment, a “cotton” calender is used, the “cotton” calender being a conventional calender alternating metal rolls and elastic rolls in which the metal rolls have been covered with a cellulose paper or with a board so as to weaken the compressive effect on the paper.

According to a preferred embodiment of the invention, the calendering parameters are defined so that the transparency of the layer after calendering is at least twice as high as that of the layer before calendering, the transparency being defined by the formula:
Transparency=100-Opacity,
the opacity being evaluated according to standard NF Q 03 006.

According to another preferred embodiment of the invention, the calendering parameters are defined so that the gloss of the sheet after calendering, measured using a BYK-Gardner glossmeter oriented at 75° with respect to the normal, is at least twice as high as that of the sheet before calendering.

The invention will be better understood with the help of the examples which will follow.

### COMPARATIVE EXAMPLE 1

An iridescent layer is deposited in a proportion of 5 g/m², using a metal blade coater, on one of the faces of a precoated paper having a grammage of approximately 100 g/m² and sold under the commercial reference Maine Club Satimat by Arjo Wiggins Papiers Couchés.

The iridescent layer composition used is as follows:

20% by dry weight of iridescent pigment of the mica coated with titanium oxide type sold under the reference Supergold by Engelhard,

80% by dry weight of a styrene-acrylic polymer binder.

### COMPARATIVE EXAMPLE 2

An iridescent layer is deposited in a proportion of 5 g/m², using a metal blade coater, on one of the faces of a transparent plastic film of the Mylar type having a grammage of approximately 90 g/m².

The iridescent layer composition used is that of example 1.

### EXAMPLE 3

An iridescent layer is deposited in a proportion of 5 g/m², using a metal blade coater, on one of the faces of the paper of example 1.

The iridescent layer composition used is as follows:

20% by dry weight of iridescent pigment of the mica coated with titanium oxide type sold under the reference Supergold by Engelhard,

80% by dry weight of an aqueous dispersion of hollow microspheres of a styrene-acrylic copolymer having a size of approximately 0.6 μm and sold under the reference Rhopaque 643 BC by Röhm & Haas.

### EXAMPLE 4

An iridescent layer is deposited in a proportion of 5 g/m², using a metal blade coater, on one of the faces of a Mylar film having a grammage of approximately 90 g/m².

The iridescent layer composition is that of example 3.

### EXAMPLE 5

An iridescent layer is deposited in a proportion of 5 g/m², using a metal blade coater, on one of the faces of the precoated paper of example 1.

The iridescent layer composition used is as follows:

20% by dry weight of iridescent pigment of the mica coated with titanium oxide type sold under the reference Supergold by Engelhard,

63% by dry weight of an aqueous dispersion of hollow microspheres of a styrene-acrylic copolymer having a size of approximately 0.6 μm and sold under the reference Rhopaque 643 BC by Röhm & Haas,

17% by dry weight of a polyvinyl-acrylic binder.

### EXAMPLE 6

An iridescent layer is deposited in a proportion of 5 g/m², using a metal blade coater, on one of the faces of a Mylar film having a grammage of approximately 90 g/m².

The iridescent layer composition used is that of example 5.

All the papers or films covered with their respective layer of the preceding examples are subsequently calendered by passing them into a calender with steel rolls which exerts a pressure of 80 N/m² on the paper during three passes, the rolls not being heated externally.

A series of tests is subsequently carried out which makes it possible to demonstrate the improvement in the transparency of the layer and in the gloss of the coated paper after calendering.

Transparency Test:

First, before calendering, the opacity on a white background of the complex formed by the Mylar film covered with the layer in examples 2, 4 and 6 is measured, this opacity being evaluated by applying standard NF Q 03-006.

The transparency of the complex is deduced therefrom by applying the formula:
Transparency=100-Opacity

The opacity on a white background of the complex is again measured after calendering and the transparency is deduced therefrom as above.

As the transparency of the Mylar substrate alone is only modified to a negligible extent during calendering, the increase in transparency of the layer after calendering is deduced therefrom by subtracting the second transparency value from the first.

Gloss Test:

The gloss of the coated paper is measured before and after calendering for examples 1, 3 and 5 using a BYK-Gardner glossmeter oriented at 75° with respect to the normal.

The increase in gloss for the coated paper is subsequently evaluated.

| | | | | Paper gloss | Paper gloss | |
|---|---|---|---|---|---|---|
| | Complex transparency | Complex transparency | Relative increase in | before | after | Relative increase in |
| | before calendering | after calendering | transparency for the layer | calendering | calendering | gloss for the paper |
| Ex 1 | | | | 35.5 | 61.3 | 72.7% |
| Ex 2 | 78.0 | 78.9 | 1.1% | | | |
| Ex 3 | | | | 34.3 | 72.7 | 112.0% |
| Ex 4 | 22.8 | 65.4 | 186.8% | | | |
| Ex 5 | | | | 26.6 | 77.7 | 192.1% |
| Ex 6 | 28.0 | 57.7 | 106% | | | |

It is thus found that the presence of hollow plastic microspheres substantially improves the increase in transparency and in gloss after calendering in comparison with an iridescent layer using a conventional binder of acrylic latex type.

This relative increase is greater than 100%, whether for the transparency of the layer or for the gloss of the coated paper.

This may result from the flattening effect exerted by the calendering presses on the plastic microspheres, which confers a better surface transparency on the layer.

1. A sheet having an iridescent appearance, characterized in that it comprises, at the surface, a layer formed from iridescent pigments as a mixture with hollow plastic microspheres.

2. The sheet as claimed in claim 1, characterized in that the iridescent pigments are of the titanium oxide-coated mica type.

3. The sheet as claimed in claim 1 or 2, characterized in that the hollow plastic microspheres are based on styrene-acrylic polymer.

4. The sheet as claimed in claim 1, characterized in that the mean diameter of the microspheres is between 0.5 μm and 1.0 μm and is preferably equal to approximately 0.6 μm.

5. The sheet as claimed in claim 1, characterized in that it is calendered and its gloss is greater than or equal to 65, as measured with a BYK-Gardner glossmeter oriented at 75° with respect to the normal.

6. The sheet as claimed in claim 1, characterized in that it is transparent or translucent and defines in particular a natural tracing paper.

7. A process for manufacturing a sheet having an iridescent appearance, characterized in that:
a substrate is coated, using a coating device, with a layer composed of a mixture of iridescent pigments and of an aqueous dispersion of hollow plastic microspheres,
the coating is dried,
the sheet thus obtained is calendered.

8. The manufacturing process as claimed in claim 7, characterized in that said substrate is a material based on cellulose fibers.

9. The manufacturing process as claimed in claim 7, characterized in that said substrate is a plastic.

10. The manufacturing process as claimed in one of claims 7 to 9, characterized in that the coating device is a metal blade coater.

11. The manufacturing process as claimed in one of claims 7 to 9, characterized in that the coating device is a curtain coater.

12. The manufacturing process as claimed in claim 7, characterized in that a steel calender is used, the sheet being calendered several times, in particular between 3 and 5 times, under a pressure of 80 N/m².

13. The manufacturing process as claimed in claim 7, characterized in that a “cotton” calender is used.

14. The manufacturing process as claimed in claim 7, characterized in that the calendering parameters are defined so that the transparency of the layer after calendering is at least twice as high as that of the coating layer before calendering, the transparency being defined by the formula:
Transparency=100-Opacity,
the opacity being evaluated according to standard NF-Q 03 006.

15. The manufacturing process as claimed in claim 7, characterized in that the calendering parameters are defined so that the gloss of the sheet after calendering, measured using a BYK-Gardner glossmeter oriented at 75° with respect to the normal, is at least twice as high as that of the sheet before calendering.
